(19) United States
(12) Patent Application Publication
(10) Pub. No.: US 2003/0017301 A1
(43) Pub. Date: Jan. 23, 2003

(54) Closure fabrication method and closure made by the method

(76) Inventor: Tony Tseng, Chang Hua Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/909,722

(22) Filed: Jul. 19, 2001

(51) Int. Cl. B32B 3/06

(52) U.S. Cl. 428/100; 156/242; 156/245; 428/195

(57) ABSTRACT

A closure fabrication method includes the steps of (a) preparing a silk screen subject to a predetermined design, (b) preparing a face member and then using the silk screen to print the predetermined design on the back of the face member, (C) preparing a heat-press mold, (d) preparing a Velcro tape, and then covering a layer of glue on the back side of the Velcro tape and the back side of the face member, (e) sealing the Velcro tape and the face member with the heat-press mold, and (f) cooling the heat-press mold so as to obtained the finished product.

### BACKGROUND OF THE INVENTION

The present invention relates to a closure, which comprises a face member silk-printed with a design, a Velcro tape, and a layer of glue bonded between the face member and the Velcro tape. The invention relates also to the fabrication of the closure.

According to a known closure fabrication method adapted to fabricate closures for use in footwear and body-protective sportswear, a label of trademark or logo is stitched to the front side of a strip of leather, and then hook and loop materials are respectively stitched to the back side of the leather. Because most part of this closure fabrication procedure is achieved by labor, the manufacturing speed is low, the manufacturing cost is high, and human error is inevitable.

### SUMMARY OF THE INVENTION

It is one object of the present invention to provide a closure fabrication method, which eliminates the aforesaid drawbacks. It is one object of the present invention to provide a closure fabrication method, which simplifies the fabrication of the closure. It is another object of the present invention to provide a closure fabrication method, which requires less labor. It is still another object of the present invention to provide a closure fabrication method, which greatly reduces the manufacturing cost of the closure. It is still another object of the present invention to provide a closure fabrication method, which greatly improves quality control. According to the present invention, the closure fabrication method includes the steps of preparing a silk screen subject to a predetermined design, (b) preparing a face member and then using the silk screen to print the predetermined design on the back of the face member, (c) preparing a heat-press mold, (d) preparing a Velcro tape, and then covering a layer of glue on the back side of the Velcro tape and the back side of the face member, (e) sealing the Velcro tape and the face member with the heat-press mold, and (f) cooling the heat-press mold so as to obtained the finished product. Because automatic machines can achieve the aforesaid steps, human error is minimized, and constant quality is achieved. Because less labor is required, the manufacturing cost of the closure is greatly reduced.

### BRIEF DESCRIPTION OF THE DRAWINGS

FIG. 1 is a block diagram explaining the fabrication procedure of the present invention.

FIG. 2 is a sectional view showing a finished closure made according to the present invention.

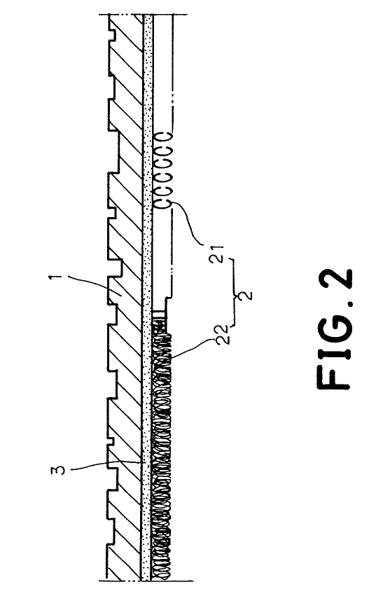

FIG. 3 is a perspective view of the finished closure of FIG. 2.

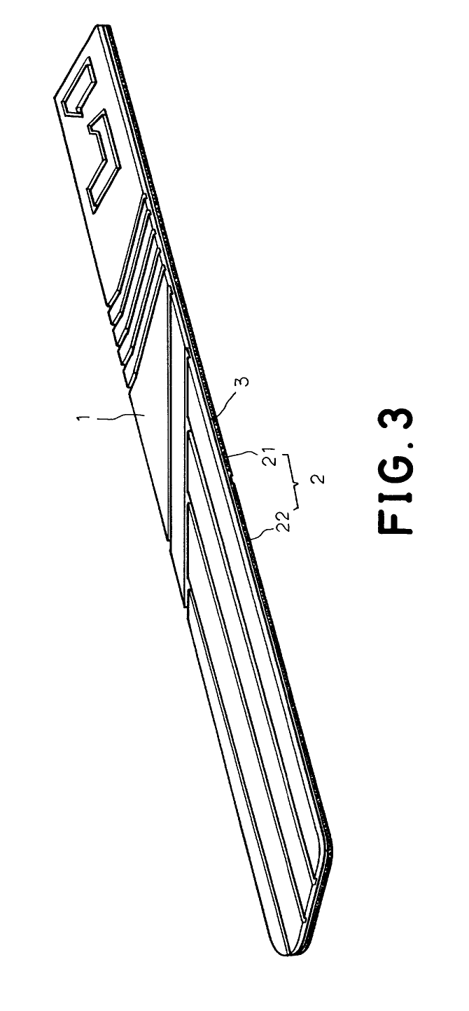

FIG. 4 is an elevational view of a face member before printing according to the present invention.

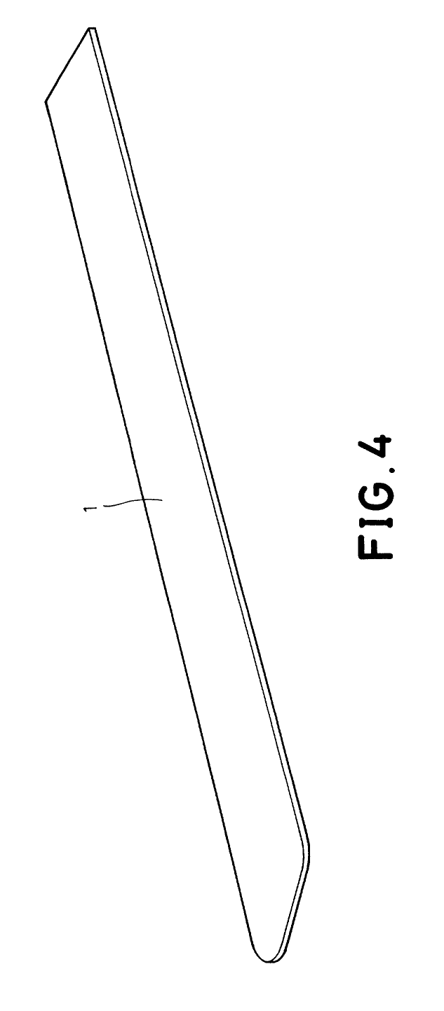

### DETAILED DESCRIPTION OF THE PREFERRED EMBODIMENT

Referring to FIG. From 1 4, the closure fabrication method of the present invention includes the steps of:

1. Preparation of silk screen where a silk screen is prepared subject to the desired design (trademark, logo, trade name, etc.);

2. Face member preparation and screen printing where a face member 1 is prepared from genuine leather, synthetic leather, fabrics, non-woven fabrics, or any of a variety of suitable materials and properly cut subject to a predetermined pattern, and then printed with the desired design, either in one color or in multiple colors as desired, by means of the application of the prepared silk screen;

3. Preparation of mold where a heat-press mold is prepared subject to the contour of the face member 1;

4. Velcro tape preparation and glue coating where a Velcro tape 2 is prepared having hook material 21 and loop material 22 bilaterally arranged on the front sidewall thereof, and a layer of glue is covered on the back sidewall of the face member 1 and/or the Velcro tape 2 by painting, spray-coating, printing, or any of a variety of suitable methods;

5. Shape forming where the prepared mold is heated to a predetermined temperature level, and then the face member 1 with the Velcro tape 2 are put in the mold, and then a pressure is employed to the mold, causing the face member 1 and the Velcro tape 2 to be sealed together; and

6. Finishing where the desired finished product is obtained after cooling of the mold.

The aforesaid procedure greatly simplifies the fabrication of the closure, and greatly reduces the manufacturing time and cost of the closure.

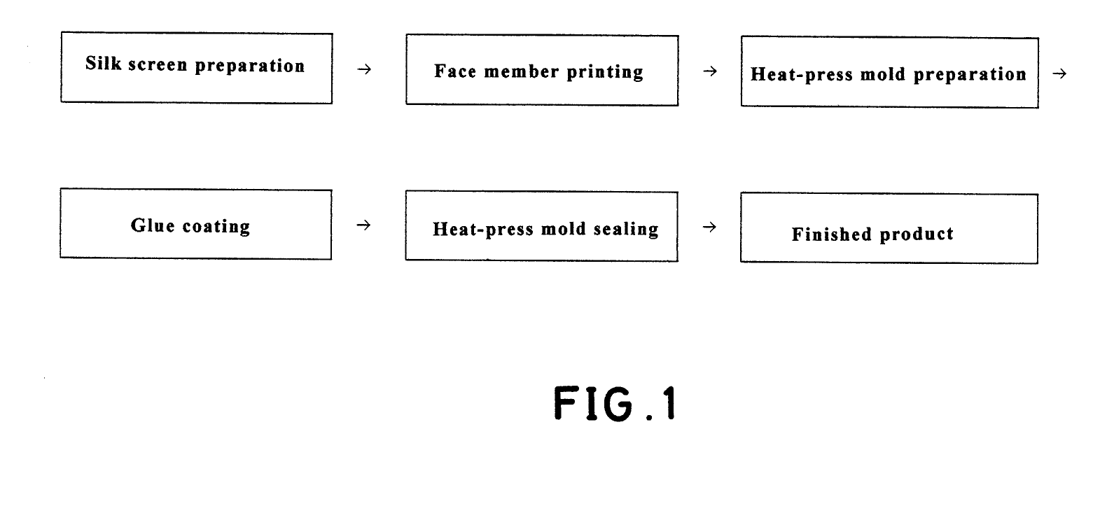

A prototype of closure fabrication method has been constructed with the features of FIGS. 1˜4. The closure fabrication method functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A closure fabrication method comprising the steps of:
(a) preparing a silk screen subject to a predetermined design;
(b) preparing a face member subject to a predetermined pattern and then using said silk screen to print said predetermined design on a front side of said face member;
(c) preparing a heat-press mold subject to the contour of said face member;
(d) preparing a Velcro tape, and then covering a layer of glue on at least one of said Velcro tape and said face member at a back side;
(e) heating said heat-press mold to a predetermined temperature level, and then putting said face member and said Velcro tape in said heat-press mold, and then applying a pressure to said heat-press mold, causing said face member and said Velcro tape to be sealed together;
(f) cooling said heat-press mold and removing the finished product from heat-press mold.

2. The closure fabrication method of claim 1 wherein said face member is prepared from genuine leather.

3. The closure fabrication method of claim 1 wherein said face member is prepared from synthetic leather.

4. The closure fabrication method of claim 1 wherein said face member is prepared from fabrics.

5. The closure fabrication method of claim 1 wherein said face member is prepared from non-woven fabrics.

6. The closure fabrication method of claim 1 wherein said silk screen is employed to print said predetermined design on said face member with a single color.

7. The closure fabrication method of claim 1 wherein said silk screen is employed to print said predetermined design on said face member with multiple colors.

8. The closure fabrication method of claim 1 wherein the step of covering a layer of glue on at least one of said Velcro tape and said face member at a back side is to cover a layer of glue on a back side of said Velcro tape.

9. The closure fabrication method of claim 1 wherein the step of covering a layer of glue on at least one of said Velcro tape and said face member at a back side is to cover a layer of glue on a back side of said face member.

10. The closure fabrication method of claim 1 wherein the step of covering a layer of glue on at least one of said Velcro tape and said face member at a back side is to cover a layer of glue on a back side of said Velcro tape and a layer of glue on a back side of said face member.

11. The closure fabrication method of claim 1 wherein said layer of glue is covered on at least one of said Velcro tape and said face member by means of one of the methods of painting, spray-coating, and printing.

12. The closure fabrication method of claim 1 wherein said Velcro tape has hook material and loop material bilaterally arranged on the front side.

13. A closure comprising a face member, said face member having a front side printed with a predetermined design and a back side, a Velcro tape, said Velcro tape having a front side, a back side, and hook material and loop material bilaterally arranged on the front side of said Velcro tape, and a layer of glue sandwiched in between said face member and said Velcro tape to secure the back side of said face member to the back side of said Velcro tape.

14. The closure of claim 13 wherein said face member is prepared from genuine leather.

15. The closure of claim 13 wherein said face member is prepared from synthetic leather.

16. The closure of claim 13 wherein said face member is prepared from fabrics.

17. The closure of claim 13 wherein said face member is prepared from non-woven fabrics.

18. The closure of claim 13 wherein said face member is printed with said predetermined design in one color.

19. The closure of claim 13 wherein said face member is printed with said predetermined design in multiple colors.
